(19) United States
(12) Patent Application Publication
(10) Pub. No.: US 2003/0231707 A1
(43) Pub. Date: Dec. 18, 2003

(54) Method and apparatus for jitter creation and testing

(76) Inventors: John Sargent French, Palm, PA (US); Jorge Eduardo Franke, Orefield, PA (US); William Joseph Thompson, Kempton, PA (US)

Correspondence Address: VOLENTINE FRANCOS, P.L.L.C., Suite 150, 12200 Sunrise Valley Drive, Reston, VA, 20191, US

(21) Appl. No.: 10/455,244

(22) Filed: Jun. 5, 2003

Related U.S. Application Data
(60) Provisional application No. 60/386,070, filed on Jun. 5, 2002.

(51) Int. Cl. H04Q 1/20

(52) U.S. Cl. 375/226

(57) ABSTRACT

A testing apparatus and method useful in measuring the performance of a receiver when receiving a relatively high frequency jittered signal. A relatively high frequency oscillator is locked to a relatively low frequency reference with intentional jitter induced by adding jitter to the relatively low frequency reference. A divide by N circuit and a phase/frequency detector are used to detect discrepancies between the relatively low frequency reference output of the oscillator and to generate a signal used to keep the oscillator locked to the relatively low frequency reference. The addition of the jitter to the relatively low frequency reference may be controlled through digital or analog means.

### CROSS-REFERENCE TO RELATED APPLICATIONS

The present application is related to U.S. Provisional Application Serial No. 60/386,070, filed Jun. 5, 2002, and entitled ‘Method and Apparatus For Jitter Creation and Testing.’ The present application claims priority from this provisional application under 35 U.S.C. §119 (e), and the disclosure of this provisional application is specifically incorporated by reference herein.

### BACKGROUND

In synchronous, serial, digital signaling, such as synchronous optical network (SONET) optical signals transmitted over optical waveguides (optical fibers), the transition between digital bits may be used to achieve bit clock alignment. When the bit clock is properly aligned, and this alignment is maintained, the transition phase may be ascertained with substantial precision. From this, signal tracking may be affected.

As is known, jitter is the short-term phase variations of the significant transitions of digital signals from their ideal positions in time. These significant instants may be any convenient, easily identifiable point on the signal (e.g., the rising or falling edge of the pulse). If an incoming optical signal at a receiver is jittered, for example because of the low power of the incoming signal, the ability of the local clocking to track the signal (referred to as clock recovery) may be hindered. This can result in bit errors at the receiver.

A recovered clock may be used in a repeater to regenerate the signal and forward the regenerated signal. Specifically, the incoming signal may be detected by the receiver in the repeater and processed and retransmitted to another receiver. In this case, the clock signal used in the retransmission may be the recovered clock.

In spans where there are chains of repeaters, such as with the long, underwater links that span oceans or seas, if uncompensated, the jitter can build up to unacceptable levels. To wit, each repeater adds to the jitter from the previous repeater as the jitter is cumulative. Thus, a receiver's response to jitter is very important and knowledge of that response is particularly important to network operators and designers.

It may be useful in the effort to measure jitter to detect the amount of temporal eye-opening in an eye diagram, a tool used to show overlap between digital ‘ones’ and ‘zeros’ in a digital signal. By observing the error rate versus sampling displacement, the fraction of useable eye may be determined. The sampling can be relocated relative to the eye by jittering the eye at a rate that is more rapid than the clock recovery of the receiving system's tracking ability. Under these circumstances, the sampling position is relatively steady and the signal is moving back and forth relative to the sampling points.

Finally, it is useful to control the amplitude and the frequency of the jitter, for example, in testing a receiver.

### SUMMARY

According to an exemplary embodiment, an apparatus for adding jitter onto a HF clock includes: an oscillator, which outputs an output HF clock; divider circuit which divides the output HF clock and outputs a divided output signal; a delay circuit, which accepts a reference clock signal and outputting a delayed reference clock signal; and a detector, which detects at least one of a phase difference and a frequency difference between the delayed reference clock signal and the divided output signal and outputs a difference signal, wherein the output HF clock is effected by said difference signal.

According to an exemplary embodiment, a testing apparatus for use in the testing of the performance of a receiver includes: an oscillator, which outputs an output HF clock; a divider circuit; which divides the output HF clock and outputs a divided output signal; a delay circuit, which accepts a reference clock signal and outputs a delayed reference clock signal; and a detector, which detects at least one of a phase difference and a frequency difference between the delayed reference clock signal and the divided output signal and outputs a difference signal, wherein the output HF clock is effected by said difference signal.

### BRIEF DESCRIPTION OF THE DRAWINGS

The invention is best understood from the following detailed description when read with the accompanying figures. It is emphasized that the various features are not necessarily drawn to scale. In fact, the dimensions may be arbitrarily increased or for clarity of discussion.

FIG. 1 is a graphical representation of eye patterns known in the art.

FIG. 2 is a graphical representation of eye patterns known in the art.

FIG. 3 is a graphical and a tabular representation of an example of receiver requirement for jitter tolerance.

FIG. 4 is a schematic diagram of a jitter generating test apparatus in accordance with an embodiment.

FIG. 5 is a flow chart of a method of testing the response of a receiver to jitter on a signal in accordance with an embodiment.

### DETAILED DESCRIPTION OF THE PREFERRED EMBODIMENTS

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

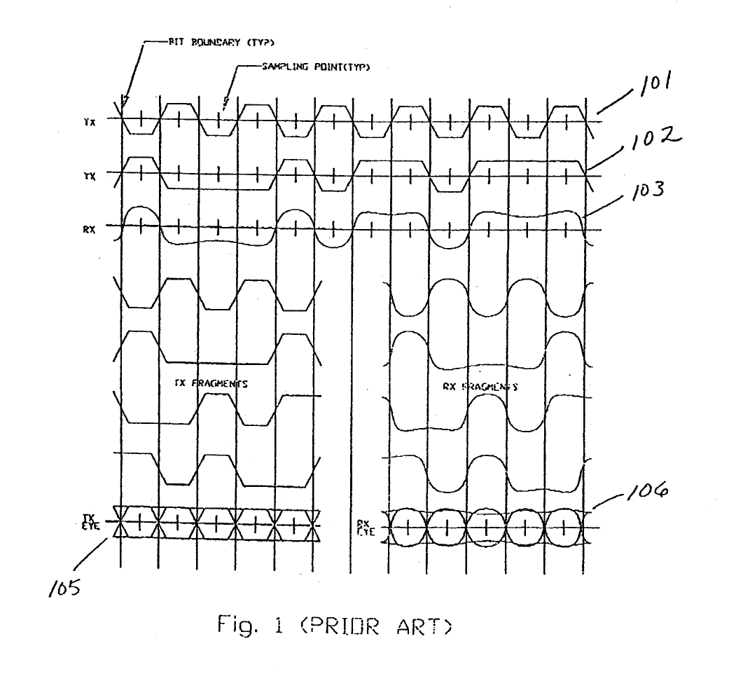

In data communications, especially in serial non-return-to-zero (NRZ) applications, eye patterns are known and used extensively for various purposes. Frequently eye patterns are used for conceptual understanding and measurement of the characteristics of a signal. FIG. 1 shows an example of a basis for obtaining eye patterns for at a transmitter transmitting a signal and at the receiver receiving the same signal.

In the top two lines of FIG. 1, the digital patterns are both marked “TX”. These patterns represent how the amplitude of the signal verses time might appear. The top pattern 101 shows how we might transmit the digital sequence: ..010101010101.. The horizontal axes show the boundary between deciding if each particular bit is a 0 or a 1. Specifically, if the amplitude is above the line, it is a 1 and if it is below the line it is a 0. The second pattern shows an exemplary digital pattern at the transmitter representing ..100010110111.. This second pattern 102 is more typical of “random data” in that it shows less regularity and not every 1 is immediately followed by a 0 and not every 0 is followed by a 1.

The sampling points shown here as short vertical lines indicate the moments when a given bit is optimally sampled and a decision is made as to whether the bit is classified as a 0 or a 1. Clearly, it is best if these sampling points are centered at each bit interval. Sometimes there is a natural way to get a stable, uniformly clocked way to specify the locations in time of these sampling points. On the transmitter side, there is usually a stable clock source that is used by the transmit circuitry to orchestrate every aspect of the data transmission. It is this clock that would be used to determine the sampling points for the transmit side if it was desirable to actually sample the transmit signal in the transmitter.

A third pattern 103 of FIG. 1 shows the signal as received at the receiver, indicated by the “RX” legend. Due to noise, and the natural properties of the transmission medium, such as a fiber optic cable, and the interconnections between the transmitter, the transmission medium, and the receiver, a typical receiver will receive a “softer” looking signal than that actually transmitted at the transmitter output. In other words, the amplitude of the transmitted signal will be more “gently rounded” at and near bit transitions when received at the receiver. Because of this rounding at and near bit transitions, the appropriate sampling points in the received signal are not as obvious as they would be at the transmitter output.

It is often one of the tasks of the receiver to “recover clock” from a received data signal. The clock recovery procedure is an attempt to best construct a clock with a phase so that the sampling points of the receiver are approximately mid-way between the observed bit transitions. The location of bit transitions are not as easily determined at the receiver end because the arrival of these transitions is dependent upon the received data pattern (not known a priori) and, as mentioned above, the rounding at and near bit transitions due to the various signal impairments from such effects as transmission medium properties, interconnections and from noise. These effects tend to make the locations of the bit transitions in the incoming signal only approximate. Most clock recovery circuits are designed to derive a clock by averaging over a large number of transitions. These circuits thus do not respond well to high frequency jitter. (In the present example, jitter may be thought of as the time offsets of the received bit transitions from their nominal positions).

The eye patterns for the transmitter and for the receiver are shown at the bottom of FIG. 1, as transmit and receive eye patterns 105 and 106, respectively. (These are also labeled “TX EYE” and “RX EYE”, respectively). As can be seen, there will be an “eye” associated with each bit interval, when the signal is viewed on an oscilloscope, for example.

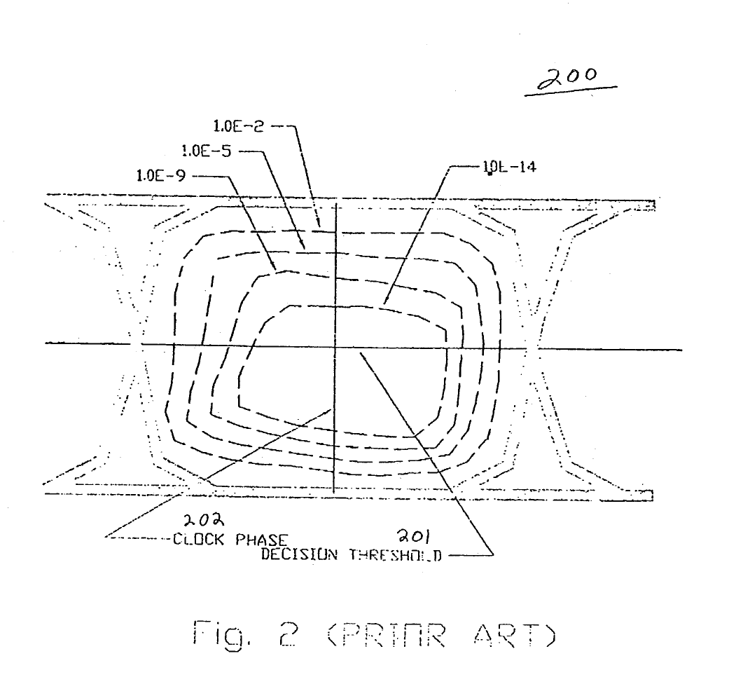

FIG. 2 shows an exemplary eye pattern 200 within a bit interval and, approximately one-third of a bit interval before the current bit interval and approximately one-third of a bit interval after the current bit interval. It is noted that “bit interval” is often referred to as unit interval (UI) when describing timing with respect to features associated with the eye pattern description.

In FIG. 2 a horizontal line represents the decision threshold 201 that is used to distinguish between a 0 and a 1. A vertical line 202 labeled “clock phase” represents the moment one intends to measure the current bit value. Because of various impairments both to the signal in transmission and present in the receiver, there is a varying probability of occasional errors in identifying bits values properly as 0s and 1s. This probability is called the “Bit Error Rate” (BER). The BER is lowest (best) when sampling of the bit occurs about in the center of the eye. In this exemplary eye representation, the BER is lower than 1.0E-14, namely, it is expected that in transmitting 10¹⁴ bits, on average less than one of those bits will be incorrectly classified.

This eye diagram 200 shows conceptually (or experimentally determined) BER for various locations within the eye pattern. The eye is said to be “open” when one has significant latitude in choosing the clock phase and decision threshold locations relative to the total pattern size and still obtains good (low) BER values. In FIG. 2, the horizontal eye opening is approximately 0.5 UI and yields a BER of 1.0E-14. Other higher BERs are shown for sampling that occurs outside the eye opening.

It is often useful to test the degree of eye opening; for example to determine if a receiver is operating within its operational specifications or meets a network operator's requirements. One way to do this is to generate a test pattern, but instead of using a high quality stable clock (as is the practice in data transmission), a jittered clock at the transmitter is used. The pattern received by the receiver would appear to have an eye that is moving slightly forward and backward in time (because of the impressed jitter on the signal). If the jitter is rapid enough, the receiver clock recovery can only operate at the average position of the transitions and cannot keep up with the transmitted eye jitter. In effect, this forces the receiver to sample the eye to the right and to the left of the center of the eye, thus determining BER performance at sampling points off of the eye center.

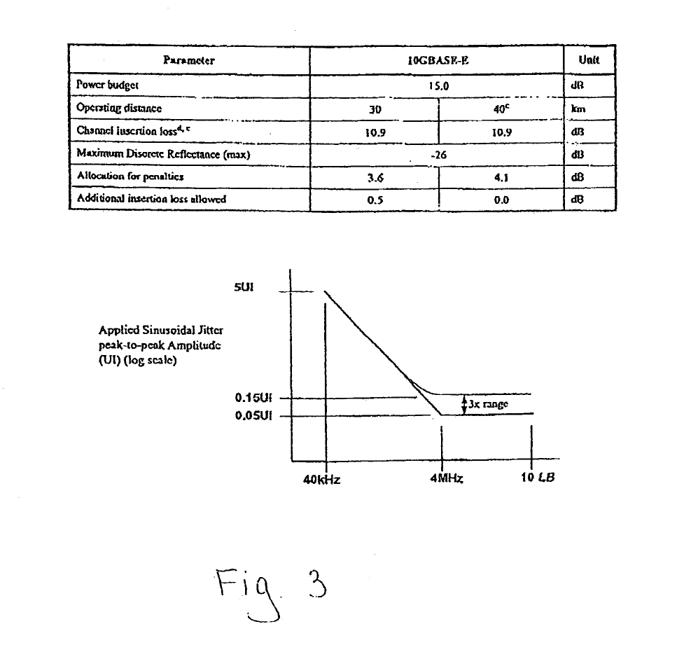

FIG. 3 is an example of the requirement that might be imposed upon a receiver's jitter tolerance, for example through its operational specifications or to meet a network operator's requirement. For this example, the receiver must maintain a BER not exceeding 10⁻¹² as the frequency of the jitter is varied and the peak-to-peak amplitude of the jitter is varied according to the graph.

If the clock recovery circuit does not follow the low frequency jitter of the eye, many errors will occur for a jitter exceeding 1.0 UI. However, at 40 kHz, the clock recovery process of the exemplary receiver normally should be tracking the eye very well for such amplitude jitter. On the other hand, when the jitter is at a frequency of several MHz, such as 4 MHz, the same amplitude jitter is not significantly tracked by the clock recovery of the exemplary receiver and the eye opening is being explored by a relatively small fraction of a UI.

The present invention as described in the exemplary embodiments is drawn to a method and apparatus for providing jitter on the transmitter. The jitter provided at the transmitter enables the determination of receiver performance based upon the observed BER.

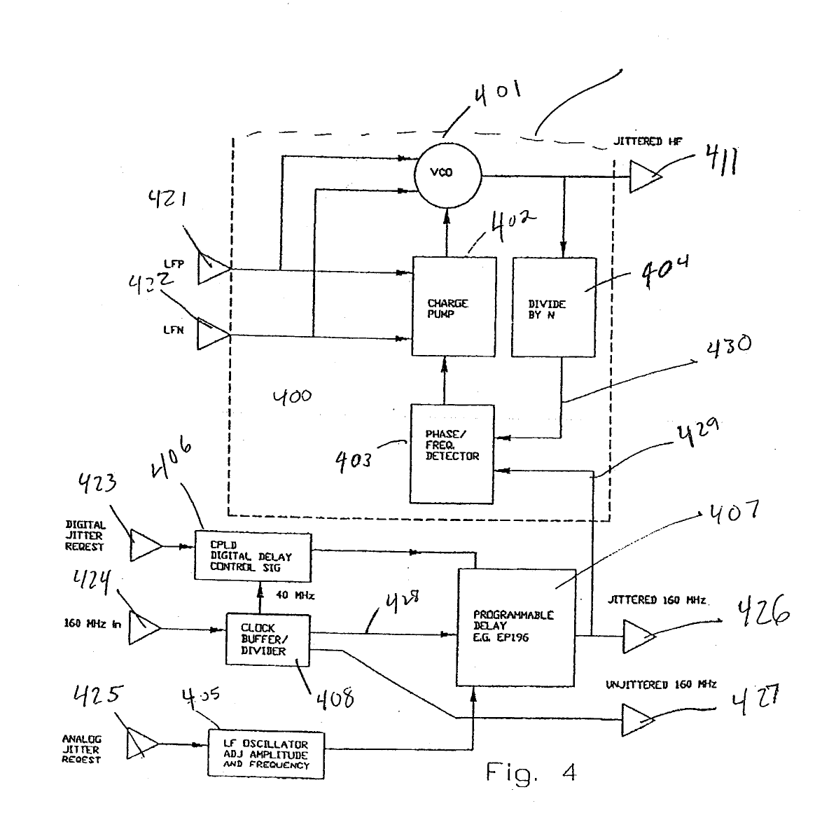

FIG. 4 is a schematic diagram an exemplary apparatus for use with analog and with digital jitter production in accordance with the present invention. It is noted that the digital and analog embodiments can be implemented together or may be implemented as separate embodiments. For ease of understanding, both embodiments are shown as implemented together in FIG. 4.

The jittered high frequency data (HF) clock 411 is output as shown. Although the HF clock 411 is shown as a single line, an embodiment of the present invention may provide for a balanced output through two leads, for instance. It is noted that an integrated circuit (IC) 400 may have additional functionality, such a the generation of a data signal. In this case, the generated HF clock 411 is used integral/internal element to the IC 400 and is an external element as shown. The jitter that is impressed upon the HF clock 411 will appear on the resulting data signal.

The transmitter clocking device to which jitter is added is illustratively a voltage controlled oscillator (VCO) 401. Depending upon the high-speed application, the VCO 401 may operate at typical rates of approximately 2.5 GHz (SONET or SDH STS-48), 10 GHz (SONET or SDH STS-192 and 10 Gb Ethernet), or 40 GHz (SONET or SDH STS-768). According to exemplary embodiments, the VCO 401 is part of the IC 400 that also contains a charge pump 402, a phase/frequency detector 403, and a divide by N counter 404. This optional integrated circuit 400 is indicated by the dashed line boundary in the figure.

Illustratively, the IC 400 is a synchronous optical networking (SONET) IC, with a SONET signal generated at approximately 10 GHz. It is noted that such an integrated circuit 400 may be obtained commercially. One such example of this integrated circuit is Agere Systems' TTRN0110G, “10 Gbits/s Clock Synthesizer, 16:1 Data Multiplexer.” While this exemplary chip has a divide by 16 (for its divide by N) other division ratios are possible in other implementations. As long as the relatively low speed reference clock 424 (here the exemplary rate is 160 MHz, but could be higher or lower to suit the technology and needs of the implementation) is operating steadily, the VCO 401 should be locked to it and operating at a steady, low jitter manner).

For purposed of illustration, the operation of the exemplary embodiment of FIG. 4 is now discussed. If a request for digital jitter is received (as will be discussed in more detail later), the relatively low frequency reference signal on line 428, utilized as a reference clock, is then shifted in phase by a change in the setting of the programmable delay 407 (such as a ON Semiconductor™ MC10EP196 or MC100EP196, or Micrel ClocKWorks™ SY10E196 or SY100E196 integrated circuit). The phase/frequency detector 403 will notice a discrepancy in the relative timing of the delayed reference clock output of programmable delay 407 on line 429 and the output of divide by N 404 on line 430. This discrepancy is detected by phase/frequency detector 403 and is passed along to the charge pump 402. VCO 401 then receives a correction from charge pump 402 that causes it to match the new phase of the delayed reference clock output of programmable delay 407. In this manner, changes in the programmable delay 407 acting upon the relatively low frequency reference signal on line 428, will be reflected in phase shifts in the VCO output 411. Specifically, if the phase of the output of programmable delay 407 on line 429 is shifted for example by 10 ps relative to the relatively low frequency reference signal on line 428, the VCO 401 will shift its phase by 10 ps in the same temporal sense. Thus, by introducing changes into programmable delay 407, jitter is introduced to the output of VCO 401.

It is noted that a delay of a very high frequency, such as produced by the VCO 401, generally at the present time cannot be handled directly by the programmable delays 407 as described herein. There are two reasons for this. First, the circuits within the programmable delay 407 may be limited, say to less than 1-2 GHz; and, second the process of changing the timing delay, for example by 10 ps, might result in an extra or missing high frequency clock transition (that are nominally spaced, perhaps 50 ps apart).

Two exemplary embodiments of the present invention include an analog method and a digital method of jittering the relatively low frequency reference signal on line 428 at programmable delay 407.

Digital jitter request input 423 may be used to initiate and end a digital jitter addition to the input signal. Analog jitter request input 425 may be used to initiate and end an analog jitter addition to the input signal.

In the exemplary analog method, a low frequency (LF) oscillator 405 is provided that is adjustable in frequency and amplitude. Such methods are well known to those skilled in the art. One can use a “programmable” potentiometer, such as the XICOR X9119 to control a LINEAR Technology LTC1799 Resister Set Oscillator. This combination produces a square wave output of a broadly settable range of frequencies. Optionally, there are methods to convert the square-wave output into a good approximation of a sine wave, if desired. In order to control the amplitude, for example, the output of the low frequency oscillator 405 and can be passed through a programmable attenuator (not shown), such as an RF Micro Devices, Inc. RF2450.

For the exemplary digital method a set of address lines is supplied to “dial in” the delay wanted at any given time. An exemplary implementation of this includes the use of a CPLD (“Complex Programable Logic Device”) 406, a known device that is programmed to supply the desired sequence of delay requests to programmable delay 407. Of course, it is understood that some other form of digital logic can be used unstead of the illustrative CPLD. In order to operate at a low enough clocking rate, the reference clock 424 may be divided down further to a manageable rate, illustratively 40 MHz, by clock buffer/divider 408. It is noted that clock buffer/divider 408 may not be necessary in all implementations. Moreover, an alternative embodiment may split the clock input 424 so as to directly provide the clock signal to both clock buffer/divider 408 and to programmable delay 407. Finally, connections 421 and 422 are external connections for resistors and capacitors, which may be useful in controlling the bandwidth of the phase-locked loop (PLL) of the IC 400.

It is noted that in setting up the programmable sequence of delay requests a sequence should be used that is timed relative to the reference clock so that the delays are not being stepped at those moments when the reference clock edges are close to being crossed by the delay switching process. If inadequate care is exercised, unwanted glitches may be input to the jittered reference clock causing in accuracies in testing.

In the example of FIG. 4, a jittered clock output 426 and an unjittered clock output 427 are also shown. These may be useful.

The examples of specific chips set forth in the description of FIG. 4 are only examples and are provided to aid in the understanding of an exemplary embodiment. These specific examples are not the only chips that may be used in the present invention and are not at all intended limit the scope of the present invention.

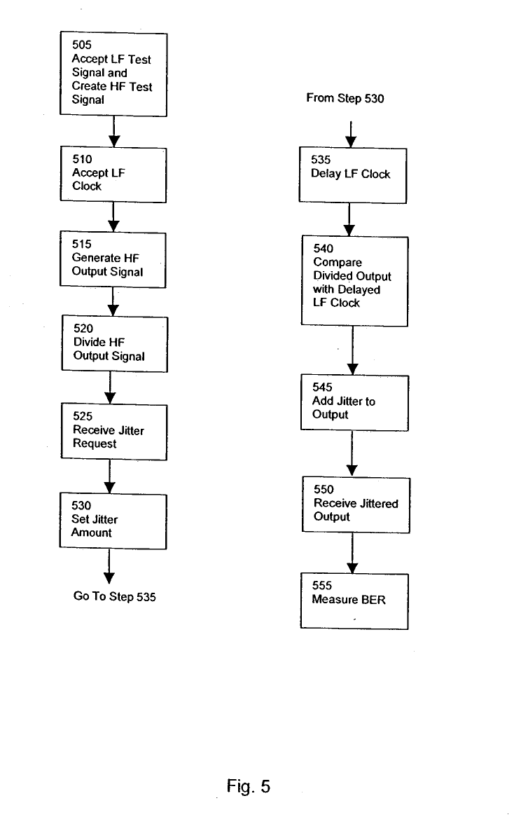

Referring now to FIG. 5, a method of generating a jittered HF clock and thereby provide a jittered data signal and utilizing the generated jittered data signal to test receiver performance 500, according to an embodiment of the present invention, is now described. In step 505, test data, such as a psuedo-random test signal, is provided to IC 400, for example, and an output signal is generated therefrom using a jittered HF clock from VCO 401, for instance. In step 510, a low frequency reference clock is also accepted by the method at clock input 424, for example.

In step 515, the frequency of the low frequency signal is increased to generate a relatively high frequency output signal. This is effectuated in the embodiment of FIG. 4 by VCO 401.

The output signal is divided to derive a relatively lower frequency signal, for example, by divide by N 404, in step 520.

In step 525, a request to add jitter to the output signal is received. In the embodiment of FIG. 4, this can come from either digital jitter request 423 or analog jitter request 425.

In step 530, a frequency and/or amplitude of jitter to be added to the output signal is set, based upon the request of step 525. This may be effectuated by CPLD 406 or low frequency oscillator 405.

In step 535, the low frequency reference clock is delayed, by programmable delay 407, for instance.

In step 540, the delayed low frequency reference clock is compared to the divided output signal to determine a difference in phase and/or frequency between the two signals, by phase/frequency detector 403, for example.

Then, in step 545, the output HF clock is altered so that it is there is no significant difference in phase and/or frequency between the divided output HF clock and the delayed low frequency clock. In the embodiment of FIG. 4, this is accomplished through charge pump 402 and VCO 401. By fluctuating the delay, through repeating steps 530 through 545, for example;jitter is created in the output HF clock.

In step 550, the jittered output signal is received at a receiver under test.

In step 555, the BER of the received signal is measured.

It is noted that the steps set forth in the jitter generation and test procedure 500 may be repeated for different frequencies and/or amplitudes of jitter as may be needed. Additionally, the steps may vary from the order set forth in FIG. 5. For example, step 510 may occur after step 530. Those of skill in the art would clearly recognize that there is flexibility in the ordering of some of these steps. Additionally, some steps, such as step 530 may be foregone, whereby the amount of jitter to be added may be predetermined. These and other variations of the illustrative process will become apparent to one of ordinary skill in the art having had the benefit of the present disclosure.

The present invention as described in the exemplary embodiments is drawn to a method and apparatus for providing jitter on the transmitter. This can be used as part of a testing device. The jitter provided at the transmitter enables the determination of receiver preformance based upon the observed BER at the receiver.

The invention having been described in detail in connection through a discussion of exemplary embodiments, it is clear that modifications of the invention will be apparent to one having ordinary skill in the art having had the benefit of the present disclosure. Such modifications and variations are included in the scope of the appended claims.

What is claimed is:

1. An apparatus for adding jitter onto a HF clock comprising:
an oscillator, which outputs an output HF clock;
a divider circuit, which divides said output HF clock and outputs a divided output signal;
a delay circuit, which accepts a reference clock signal and outputs a delayed reference clock signal; and
a detector, which detects at least one of a phase difference and a frequency difference between said delayed reference clock signal and said divided output signal and outputs a difference signal, wherein said output HF clock is effected by said difference signal.

2. An apparatus as in claim 1, wherein said divider circuit is a divide by N circuit.

3. An apparatus as in claim 1, further comprising a charge pump, said charge pump accepting said difference signal and affecting said oscillator based upon said difference signal, and wherein said oscillator is a voltage controlled oscillator.

4. An apparatus as in claim 1, wherein said delay circuit is programmable.

5. An apparatus as in claim 4, further comprising:
a complex programmable logic device (CPLD), which controls said programmable delay circuit; and
a clock divider, which divides said reference clock signal and outputs a divided reference clock signal to said CPLD.

6. An apparatus as in claim 4, further comprising a low frequency oscillator, which generates an analog signal and provides said analog signal to said programmable delay.

7. An apparatus as in claim 6, wherein said analog signal is adjustable in frequency and amplitude.

8. An apparatus as in claim 1, further comprising an output jittered clock.

9. An apparatus as in claim 8, further comprising an output unjittered clock.

10. An apparatus as in claim 4, further comprising:
a complex programmable logic device (CPLD), which controls said programmable delay circuit;
a clock divider; which divides said reference clock signal and outputs a divided reference clock signal to said CPLD; and
an adjustable low frequency oscillator, which generates an analog signal and provides said analog signal to said programmable delay, wherein said analog signal is adjustable in frequency and amplitude.

11. A method of adding jitter to an output HF clock, the method comprising:
creating said output HF clock based upon said input signal;
accepting a reference clock signal;
delaying said reference clock signal;
dividing said output HF clock;
detecting at least one of a phase difference and a frequency difference between said delayed reference clock signal and said divided HF clock;
effecting said output HF clock based upon said detection.

12. A method as in claim 11, wherein said dividing step divides said output signal by N.

13. A method as in claim 11, the method further comprising setting an amount of delay to be provided in said delaying step.

14. A method as in claim 13, wherein said setting is affected by at least one of a digital jitter request and an analog jitter request.

15. An testing apparatus for use in the testing of the performance of a receiver comprising:
an oscillator, which outputs an output HF clock;
a divider circuit, which divides said output HF clock and outputs a divided output signal;
a delay circuit, which accepts a reference clock signal and outputs a delayed reference clock signal; and
a detector, which detects at least one of a phase difference and a frequency difference between said delayed reference clock signal and said divided output signal and outputs a difference signal, wherein said output HF clock is effected by said difference signal.

16. An apparatus as in claim 15, wherein said divider circuit is a divide by N circuit.

17. An apparatus as in claim 15, further comprising a charge pump, which accepts said difference signal and effects said oscillator based upon said difference signal, and wherein said oscillator is a voltage controlled oscillator.

18. An apparatus as in claim 15, wherein said delay circuit is programmable.

19. An apparatus as in claim 18, further comprising:
a complex programmable logic device, which controls said programmable delay circuit; and
a clock divider; which divides said reference clock signal and outputs a divided reference clock signal to said CPLD.

20. An apparatus as in claim 18, further comprising a low frequency oscillator, which generates an analog signal and provides said analog signal to said programmable delay.

21. An apparatus as in claim 20, wherein said analog signal is adjustable in frequency and amplitude.

22. An apparatus as in claim 15, further comprising an output jittered clock.

23. An apparatus as in claim 22, further comprising an output unjittered clock.

24. An apparatus as in claim 18, further comprising:
a CPLD, which controls said programmable delay circuit;
a clock divider, which divides said reference clock signal and outputs a divided reference clock signal to said CPLD; and
an adjustable low frequency oscillator, which generates an analog signal and provides said analog signal to said programmable delay, said analog signal is adjustable in frequency and amplitude.

25. A method of testing the performance of a receiver comprising:
accepting an input test data pattern and generating an output testing signal therefrom and from an HF clock;
accepting a reference clock signal;
delaying said reference clock signal;
dividing said output HF clock;
detecting at least one of a phase difference and a frequency difference between said delayed reference clock signal and said divided output HF clock;
jittering said output HF clock based upon said detection;
receiving said jittered output testing signal at said receiver; and
measuring a Bit Error Rate of said received jittered output testing signal.

26. A method as in claim 25, wherein said jittering comprises:
changing at least one of a phase and frequency of said output test signal based upon said detection;
changing said delay in said delayed reference clock signal;
dividing said changed output HF clock;
a second detecting step of detecting at least one of a phase difference and a frequency difference between said changed delayed reference clock signal and said changed output HF clock; and
changing at least one of a phase and frequency of said changed output test signal based upon said second detection.

27. A method as in claim 25, wherein said dividing divides said output HF clock by N.

28. A method as in claim 25, further comprising setting an amount of delay to be provided in said delaying.

29. A method as in claim 28, wherein said setting is affected by at least one of a digital jitter request and an analog jitter request.
